(19) United States
(12) Patent Application Publication
(10) Pub. No.: US 2006/0105588 A1
(43) Pub. Date: May 18, 2006

(54) Telephone design and handset placement on inmate telephones to reduce the possibility of hanging, strangulation, or death

(75) Inventor: Scott Seay, Cumming, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Telcom Marketing Group, Inc.

(21) Appl. No.: 11/264,960

(22) Filed: Nov. 1, 2005

Related U.S. Application Data
(60) Provisional application No. 60/623,850, filed on Nov. 1, 2004.

(51) Int. Cl. H01R 39/00

(52) U.S. Cl. 439/21

(57) ABSTRACT

Disclosed is a telephone that comprises a telephone handset, a cord, and a housing. The cord has first and second ends, with the first end of the cord being attached to the telephone handset. The housing is mounted on a mounting surface and has a front wall, top wall, bottom wall, back wall, and side walls, with the front wall having a cradle that supports the telephone handset. The back wall of the housing is designed to be mounted on the mounting surface. The second end of the cord is attached to the top wall of the housing or on the front wall of the housing above the cradle. By attaching the cord to the top of the telephone, or above the cradle, and the length of the handset cord is reduced to eighteen inches or less; thus, the possibility of strangulation is greatly reduced.

### CROSS-REFERENCE TO RELATED APPLICATION

This application claims priority to copending U.S. provisional application entitled, “TELEPHONE DESIGN AND HANDSET PLACEMENT ON INMATE TELEPHONES TO REDUCE THE POSSIBILITY OF HANGING, STRANGULATION, OR DEATH” filed on Nov. 1, 2004 and accorded Ser. No. 60/623,850, which is entirely incorporated herein by reference.

### TECHNICAL FIELD

The present invention is generally related to a telephone apparatus, and more particularly, it relates to a telephone apparatus for use by an inmate in a prison.

### BACKGROUND

FIG. 1 illustrates a front view of a telephone 1 that includes a housing 3, a cord 5, and a telephone handset (not shown). The housing 3 of the telephone 1 includes a front wall 7, top wall 9, bottom wall 11, and side walls 13, 15. The cord 5 is attached to the bottom wall 5. Typically, the housing 3 is mounted on a mounting wall at a height of approximately a user's chest level such that a user can easily access the telephone handset and dial on push buttons 17. This results in a cord 5 that has a length of approximately twenty (20) inches or more so that the user can conveniently use the telephone handset. In a prison, a twenty-inch cord can be used to be wrapped around the neck of an individual and strangulation or death could occur.

Thus, a heretofore unaddressed need exists in the industry to address the aforementioned deficiencies and inadequacies.

### SUMMARY

Briefly described, in one embodiment of a telephone, among others, the telephone comprises a telephone handset, a cord, and a housing. The cord has first and second ends, with the first end of the cord being attached to the telephone handset. The housing is mounted on a mounting surface and has a front wall, top wall, bottom wall, back wall, and side walls, with the front wall having a cradle that supports the telephone handset. The back wall of the housing is designed to be mounted on the mounting surface. The second end of the cord is attached to the top wall of the housing or on the front wall of the housing above the cradle. By attaching the cord to the top wall of the telephone, or on the front wall above the cradle, and the length of the handset cord is reduced to eighteen inches or less; thus, the possibility of strangulation is greatly reduced.

Other apparatuses, methods, features, and advantages of the present invention will be or become apparent to one with skill in the art upon examination of the following drawings and detailed description. It is intended that all such additional apparatuses, methods, features, and advantages be included within this description, be within the scope of the present invention, and be protected by the accompanying claims.

### BRIEF DESCRIPTION OF THE DRAWINGS

FIG. 1 is a front view of a telephone having a cord attached to a bottom wall of a telephone housing.

FIG. 2 is a front view of an embodiment of a telephone having a cord attached to a top wall of a telephone housing.

FIG. 3 is a front view of the telephone shown in FIG. 2 having a telephone handset that hangs off a cradle.

FIG. 4 is a front view of an embodiment of a telephone having a cord attached to a front wall of a telephone housing above a cradle.

### DETAILED DESCRIPTION OF THE PREFERRED EMBODIMENT

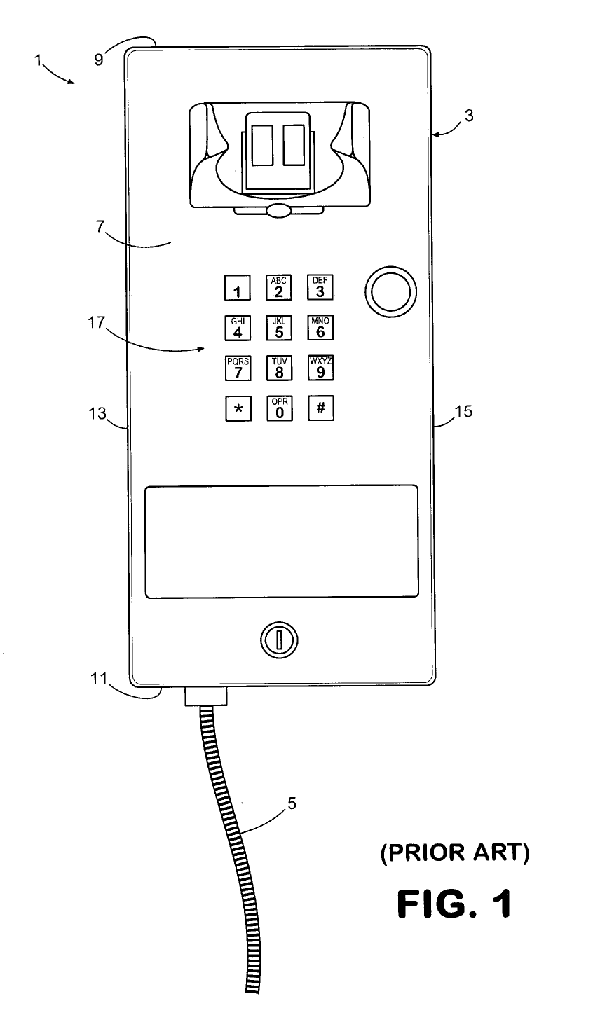

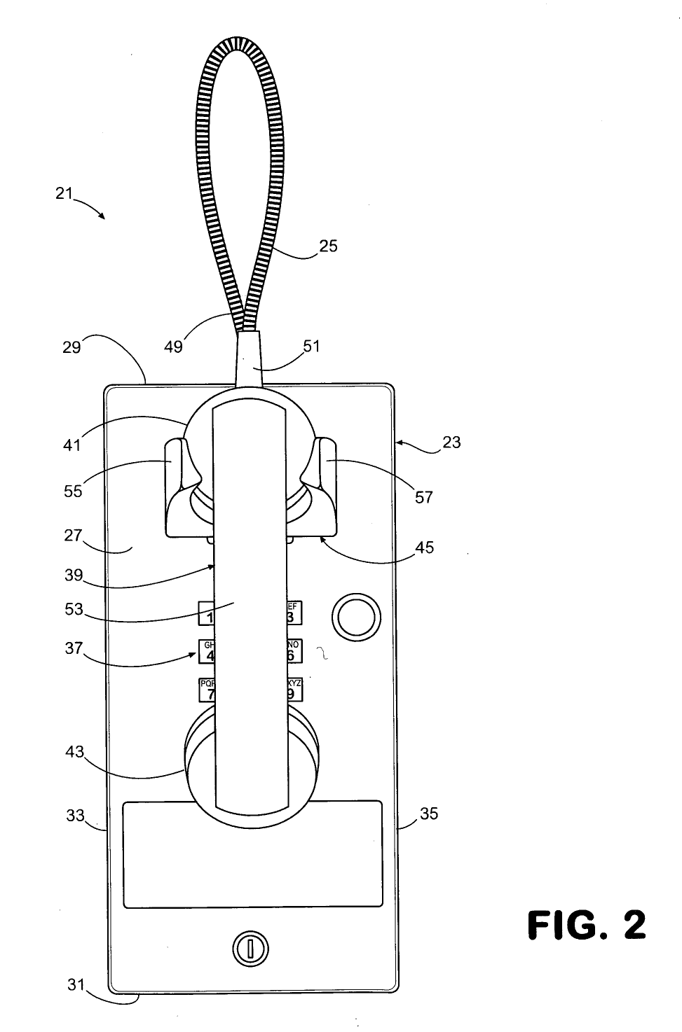

Disclosed is a telephone that reduces the length of a telephone code to eighteen inches or less; thus, reducing the possibility of strangulation. FIG. 2 is a front view of an embodiment of a telephone having a cord attached to a top wall of a telephone housing. The telephone 21 shown in FIG. 2 is substantial similar to the telephone 1 shown in FIG. 1, and thus, includes a housing 23, cord 25, and telephone handset 39. The cord 25 has first and second ends 49, 51, with the first end 51 of the cord 25 being attached to the telephone handset 39. The housing 23 is mounted on a mounting surface (not shown) and has a front wall 27, top wall 29, bottom wall 31, back wall (not shown) and side walls 33, 35, with the front wall 27 having a cradle 45 that supports the telephone handset 39. The back wall of the housing 23 is designed to be mounted on the mounting surface. The second end 49 of the cord 25 is attached to the top wall 29 of the housing 23. By attaching the cord 25 to the top wall 29 of the telephone 1, the length of the cord 25 is reduced to eighteen inches or less; thus, reducing the possibility of strangulation.

The front wall 27 further has dialing buttons 37 and the telephone handset 39 has a handle 53 having first and second ends 43, 41. The first and second ends 43, 41 of the handle 53 has a speaker and a microphone (both not shown) respectively. The first end 51 of the cord 25 is attached to the first end 41 of the telephone handset 39, which is used to hang on the cradle 45. In an alternative embodiment, if the telephone apparatus is placed at a user's head level, it would be appreciated that the first end 51 of the cord can be attached to the second end 43 of the telephone handset 39 such that the length of the cord 25 is reduced to eighteen inches or less.

The cradle 45 is a shape of a letter C, with the ends 55, 57 of the cradle 45 extending away from the mounting surface. It would be appreciated that the cradle 45 can be any shape that compliments the handset 39 to support the telephone handset 39. The telephone 21 further includes a frequency generator (not shown) that is electrically connected to the dialing buttons and generates electrical signals operative for dialing the telephone. A ringer can be included in the telephone 21, which rings when the telephone receives a call.

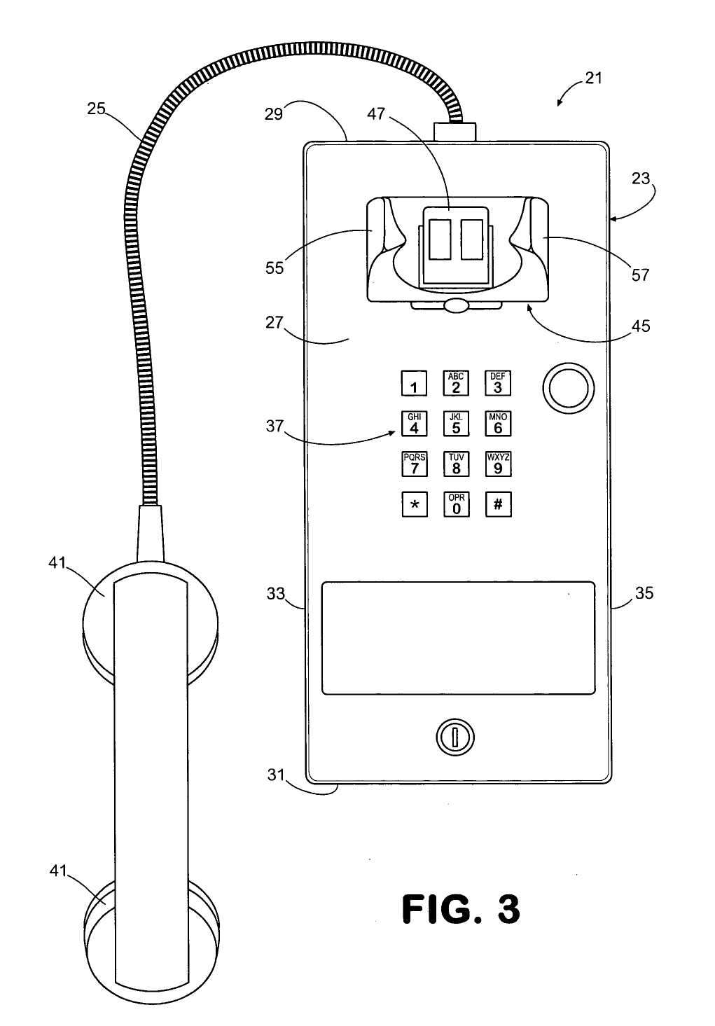

FIG. 3 is a front view of the telephone shown in FIG. 2 having the handset 39 that hangs off the cradle 45. The cradle 45 has an on-hook lever 47 that is operatively attached through the front wall 27 of the housing 23. The on-hook lever 47 is placed at the base of the C-shaped cradle 45 and is capable of switching the telephone 21 to an on-hook condition when the telephone handset 39 is hung on the cradle 45.

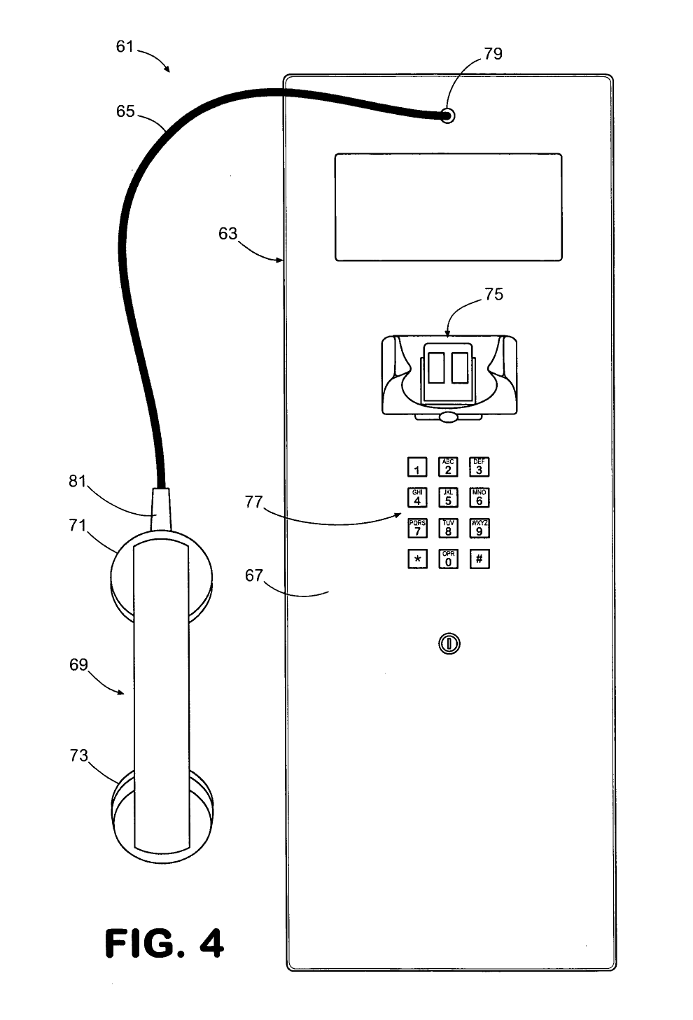

FIG. 4 is a front view of an embodiment of a telephone having a cord attached to a front wall of a telephone housing above a cradle. The telephone 61 shown in FIG. 4 is substantial similar to the telephone 21 shown in FIG. 2, and thus, includes a housing 63, cord 65, telephone handset 69, cradle 75, and dial buttons 77. The housing 63 has a front wall 67 that includes the dial buttons 77 place substantially in the middle of the front wall and the cradle 75 placed above the dial buttons 77. The cord 65 has first and second ends 81, 79, with the first end 81 of the cord 65 being attached to the telephone handset 71. The second end 79 of the cord 65 is attached to the front wall 67 of the housing 63 above the cradle 75. By attaching the cord 65 to the front wall 67 of the housing 63 above the cradle 75, the length of the cord 65 is reduced to eighteen inches or less; thus, reducing the possibility of strangulation.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A telephone, comprising:
a telephone handset;
a cord having first and second ends, with the first end of the cord being attached to the telephone handset; and
a housing having a front wall, top wall, bottom wall, back wall and side walls, with the top wall being in the top position when the housing is mounted on a mounting surface, the back wall of the housing being designed to be mounted on the mounting surface,
wherein the second end of the cord being attached to the top wall of the housing.

2. The telephone of claim 1, wherein the length of the cord is approximately no more than eighteen inches.

3. The telephone of claim 1, wherein the front wall has a cradle for storing the telephone handset and dialing buttons.

4. The telephone of claim 3, wherein the telephone handset includes a handle having first and second ends, a speaker, and a microphone, with the first end of the handle having the speaker and the second end of the handle having the microphone.

5. The telephone of claim 4, wherein the first end of the cord is attached to the first end of the telephone handset, which is used to hang on the cradle.

6. The telephone of claim 4, wherein the first end of the cord is attached to the second end of the telephone handset, which is used to hang on the cradle.

7. The telephone of claim 3, wherein the cradle is a shape of a letter C, with ends of the cradle extending away from the mounting surface, wherein the cradle supports the telephone handset in an on-hook condition.

8. The telephone of claim 4, wherein the cradle has a on-hook lever that is operatively attached through the front wall of the housing to the telephone apparatus, the on-hook lever being placed at a base of the C-shaped cradle and being capable of switching the telephone to an on-hook condition when the telephone handset is hung on the cradle.

9. The telephone of claim 4, further comprising a frequency generator that is electrically connected to the dialing buttons and generates electrical signals operative for dialing the telephone.

10. The telephone of claim 4, further comprising a ringer that rings when the telephone receives a call.

11. A telephone, comprising:
a telephone handset;
a cord having first and second ends, with the first end of the cord being attached to the telephone handset; and
a housing being mounted on a mounting surface and having a front wall, top wall, bottom wall, back wall, and side walls, the front wall having a cradle that supports the telephone handset, the back wall of the housing being designed to be mounted on the mounting surface, wherein the second end of the cord being attached on the front wall of the housing above the cradle.

12. The telephone of claim 11, wherein the length of the cord is approximately no more than eighteen inches.

13. The telephone of claim 12, wherein the front wall has dialing buttons.

14. The telephone of claim 13, wherein the telephone handset includes a handle having first and second ends, an speaker, and a microphone, with the first end of the handle having the speaker and the second end of the handle having the microphone.

15. The telephone of claim 14, wherein the first end of the cord is attached to the first end of the telephone handset, the handset being hung on the cradle using the first end of the handle.

16. The telephone of claim 13, wherein the cradle is a shape of a letter C, with the ends of the cradle extending away from the front wall of the housing, wherein the cradle supports the telephone handset in an on-hook condition.

17. The telephone of claim 14, wherein the cradle has a on-hook lever that is operatively attached through the front wall of the house to the telephone apparatus, the on-hook lever being placed at the base of the C-shaped cradle and being capable of switching the telephone to an on-hook condition when the telephone handset is hung on the cradle.

18. The telephone of claim 14, further comprising a frequency generator that is electrically connected to the dialing buttons and generates electrical signals operative for dialing the telephone.

19. The telephone of claim 14, further comprising a ringer that rings when the telephone receives a call.

20. A telephone, comprising:
a housing containing the telephone, said housing being designed to be fixedly attached to a mounting surface, said housing having a front wall, top wall, bottom wall, back wall and side walls, with the top wall being designed to be in the top position when the housing is mounted on a mounting surface, said back wall of the housing being designed to be mounted on the mounting surface;
a telephone handset with a microphone and a speaker; and
a telephone cord having first and second ends, with the first end attached to the telephone handset near the microphone and the second end connected to the telephone apparatus through the top wall of the housing.
